(19) United States
(12) Patent Application Publication
(10) Pub. No.: US 2013/0169985 A1
(43) Pub. Date: Jul. 4, 2013

(54) IMAGE FORMING DEVICE, IMAGE FORMING METHOD, AND NON-TRANSITORY COMPUTER READABLE MEDIUM

(71) Applicants: Kohshiro INOMATA, Kanagawa (JP); Hirochika SHIONOIRI, Kanagawa (JP)

(72) Inventors: Kohshiro INOMATA, Kanagawa (JP); Hirochika SHIONOIRI, Kanagawa (JP)

(73) Assignee: FUJI XEROX CO., LTD., Tokyo (JP)

(21) Appl. No.: 13/465,519

(22) Filed: May 7, 2012

(30) Foreign Application Priority Data
Dec. 28, 2011 (JP) 2011-287606

(51) Int. Cl. G06K 15/02

(52) U.S. Cl. 358/1.13

(57) ABSTRACT

An image forming device includes an image reading unit that reads an image on an original and generates image data, and a file name setting unit that sets time and user identification information of a default file name to time when an image is read by the image reading unit and user identification information of a user instructing the image reading unit to read the image, and gives a set file name to the image data generated by the image reading unit, in a case where the default file name indicated in a form including a character string registered in advance, the time, and the user identification information for identifying a user are received, and the image is read by the image reading unit.

### CROSS-REFERENCE TO RELATED APPLICATIONS

This application is based on and claims priority under 35 USC 119 from Japanese Patent Application No. 2011-287606 filed Dec. 28, 2011.

### BACKGROUND

(i) Technical Field

The present invention relates to an image forming device, an image forming method, and a non-transitory computer readable medium.

(ii) Related Art

There are cases where an original is read by an image forming device having a scanner function so as to generate electronic image data, a file name is given to the image data which is transmitted to a personal computer or a server via a communication path such as a network, and the image data is preserved in the personal computer or the server. As methods for giving a file name to image data, there are a method of using a user name which is input from a keyboard by a user as the file name, a method of using simple continuous numbers as the file name, a method of using the date as the file name, and the like.

### SUMMARY

According to an aspect of the invention, there is provided an image forming device including an image reading unit that reads an image on an original and generates image data; and a file name setting unit that sets time and user identification information of a default file name to time when an image is read by the image reading unit and user identification information of a user instructing the image reading unit to read the image, and gives a set file name to the image data generated by the image reading unit, in a case where the default file name indicated in a form including a character string registered in advance, the time, and the user identification information for identifying a user are received, and the image is read by the image reading unit.

### BRIEF DESCRIPTION OF THE DRAWINGS

Exemplary embodiments of the present invention will be described in detail based on the following figures, wherein:

FIG. 1 is a block diagram illustrating an image forming system according to an exemplary embodiment of the invention;

FIG. 2 is a functional block diagram of the image forming device according to the exemplary embodiment of the invention;

FIG. 3 is a diagram illustrating an example of the screen for generating a form of the default file name;

FIG. 4 is a diagram illustrating an example of the screen for generating a form of the default file name;

FIG. 5 is a diagram illustrating an example of the file name management information;

FIG. 6 is a diagram illustrating an example of the file name management information;

FIG. 7 is a flowchart illustrating an example of the processes performed by the image forming device according to the exemplary embodiment of the invention;

FIG. 8 is a diagram illustrating an example of the screen displayed on the image forming device;

FIG. 9 is a diagram illustrating an example of the screen displayed on the image forming device;

FIG. 10 is a diagram illustrating an example of the screen displayed on the image forming device;

FIG. 11 is a diagram illustrating an example of the screen displayed on the image forming device; and

FIG. 12 is a diagram illustrating an example of the screen displayed on the image forming device.

### DETAILED DESCRIPTION

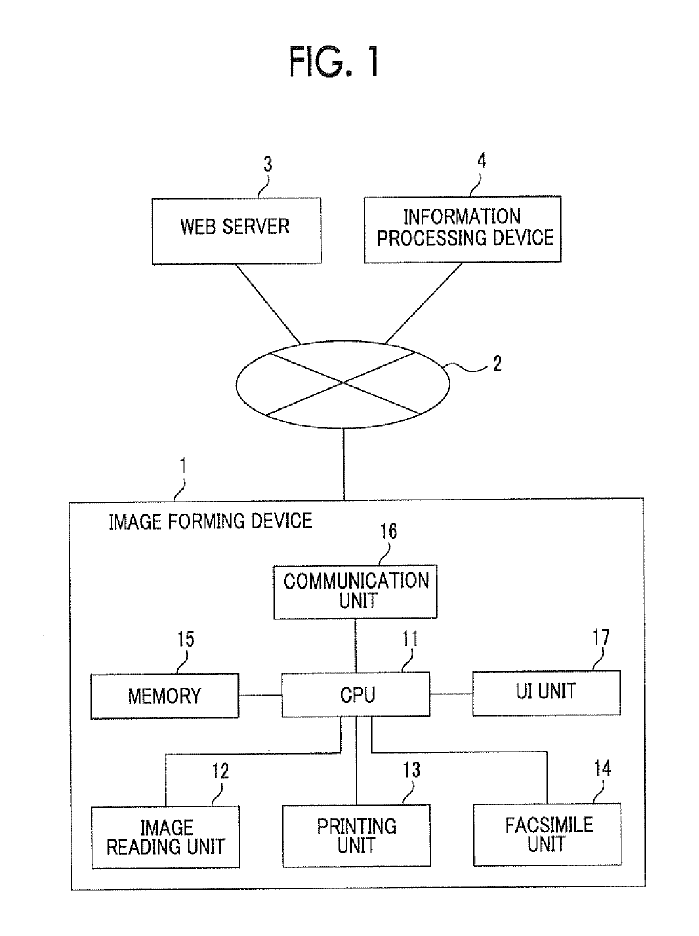

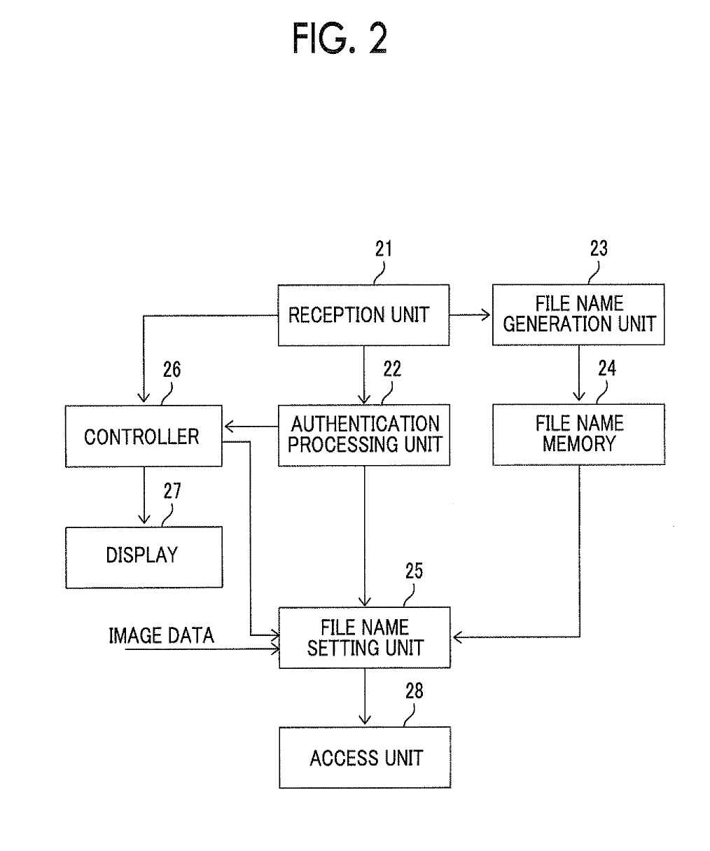

With reference to FIGS. 1 and 2, an image forming device and a program according to an exemplary embodiment of the invention will be described. FIG. 1 shows an example of the image forming system according to the exemplary embodiment of the invention. The image forming system includes, for example, an image forming device 1, a web server 3 which provides a web service to the image forming device 1, and an information processing device 4 such as a personal computer. The image forming device 1, the web server 3, and the information processing device 4 are connected to a communication path 2. The image forming device 1 accesses the web server 3 and the information processing device 4 via the communication path 2 so as to transmit data to the web server 3 and the information processing device 4 or receive data from the web server 3 and the information processing device 4. For example, the image forming device 1 reads an image on an original so as to be converted into electronic image data, gives a file name to the image data, and transmits the image data to the web server 3 or the information processing device 4 via the communication path 2. Although, in the example shown in FIG. 1, the single web server 3 and the single information processing device 4 are shown, plural web servers 3 and plural information processing devices 4 may be connected to the communication path 2. In addition, plural image forming devices 1 may be connected to the communication path 2.

The communication path 2 includes, for example, a network such as a LAN (Local Area Network) or a WAN (Wide Area Network).

Web services provided by the web server 3 include, for example, a service for receiving and storing image data generated by the image forming device 1, a service for providing images or documents so as to be viewed using the image forming device 1 or downloading images or documents to the image forming device 1, and the like.

Image Forming Device 1

The image forming device 1 has a scanning function for reading an image on an original so as to be converted into electronic image data. For example, the image forming device 1 has functions such as a scanner function, a copier function, a printer functions, and a facsimile function. However, functions thereof are not limited thereto, and a scanner and the like which do not have a printing function are included in the scope of the image forming device 1 according to the exemplary embodiment. The image forming device 1 is installed at environments where plural users commonly use the image forming device 1, such as, for example, offices, convenience stores, libraries, hotels, or apartments.

The image forming device 1 includes, for example, a CPU (Central Processing Unit) 11, an image reading unit 12, a printing unit 13, a facsimile unit 14, a memory 15, a communication unit 16, and a UI (User Interface) unit 17. The CPU 11 controls the overall image forming device 1. The image reading unit 12 reads an image on an original, generates image data indicating the image, and stores the image data in the memory 15. The printing unit 13 prints an image on a paper sheet. The facsimile unit 14 facsimiles an image. The memory 15 includes an HDD (Hard Disk Drive), a RAM (Random Access Memory), a ROM (Read Only Memory), or the like, and stores programs executed by the CPU 11, control data, image data, and the like. The communication unit 16 is, for example, a network interface, and causes the image forming device 1 to be connected to the communication path 2 so as to transmit data to the web server 3 and the information processing device 4 and receive data from the web server 3 and the information processing device 4. The UI unit 17 includes, for example, an input section and a display section, and receives a variety of information input by a user or displays a screen regarding an image process. In addition, the image forming device 1 may have a copier function where the image reading unit 12 reads an image on an original, and the printing unit 13 prints the read image on a paper sheet, thereby copying the image on the original on the paper sheet.

Next, a description will be made of an example of the function of the image forming device 1 where image data which is generated and acquired by the image reading unit 12 is given a file name and is transmitted to the external devices connected via the communication path with reference to FIG. 2. FIG. 2 is a functional block diagram illustrating an example of the function of the image forming device 1 for giving a file name to image data generated by the image reading unit 12. The image forming device 1 includes a reception unit 21, an authentication processing unit 22, a file name generation unit 23, a file name memory 24, a file name setting unit 25, a controller 26, a display 27, and an access unit 28.

Reception Unit 21

The reception unit 21 receives inputs of a variety of information by a user from the UI unit 17 or receives inputs of a variety of information by the communication unit 16 via the communication path 2. For example, the reception unit 21 receives authentication information regarding use authority of the image forming device 1 from the UI unit 17. The authentication information regarding use authority of the image forming device 1 is information which is authenticated by the image forming device 1 and is used to log in to the image forming device 1, and includes user identification information for identifying a user using the image forming device 1 and a password for logging in to the image forming device 1. The user identification information corresponds to, for example, a user ID, a user name, or the like. In the following description, authentication information regarding use authority of the image forming device 1 is referred to as “device authentication information”, user identification information for identifying a user using the image forming device 1 is referred to as “device user identification information”, and a password for the image forming device 1 is referred to as a “device password”. In addition, a user ID for identifying a user using the image forming device 1 is referred to as a “device user ID”. The reception unit 21 outputs device authentication information to the authentication processing unit 22.

For example, in a case where a user inputs a device user identification information and a device password by the use of the UI unit 17 such that the user is authenticated by the image forming device 1 and logs in to the image forming device 1, the reception unit 21 receives the device user identification information and the device password from the UI unit 17 and outputs device authentication information including the device user identification information and the device password to the authentication processing unit 22.

There is a method of using an IC card or using a software keyboard as methods of inputting device authentication information to the image forming device 1. For example, the image forming device 1 may be provided with a card reader, an IC card storing device authentication information therein may be touched on the card reader, thereby inputting the device authentication information stored in the IC card to the image forming device 1. For example, in a case where the image forming device 1 is installed in an office, an employee number and a device password as the device user identification information may be stored in an employee IC card, and the employee IC card may be touched on the card reader, thereby inputting the device authentication information to the image forming device 1.

In addition, the reception unit 21 accesses the web server 3 from the image forming device 1 and receives authentication information for using a web service from the UI unit 17. The authentication information for using a web service includes user identification information for identifying a user using the web service and a password for logging in on the web service. The user identification information corresponds to, for example, a user ID (account), a user name, or the like. In a case where a user is authenticated by the web server 3 using the authentication information for a web service, and the authentication is successful, the authenticated user is allowed to access the web server 3 from the image forming device 1 and is thus allowed to use the web service. In the following description, authentication information for using a web service is referred to as “service authentication information”, user identification information for identifying a user using the web service is referred to as “service user identification information”, and a password for the web service is referred to as a “service password”. In addition, a user ID for identifying a user using the web service is referred to as a “service user ID”.

Authentication Processing Unit 22

The authentication processing unit 22 receives the device authentication information from the reception unit 21 and performs an authentication process of the user for the image forming device 1 on the basis of the device authentication information. For example, the authentication processing unit 22 performs the authentication process of the user by referring to device authentication information which is registered in the image forming device 1 in advance. As an example, device authentication information including device user identification information for identifying a user authenticated by the image forming device 1 and a device password are stored in the memory 15 in advance. The authentication processing unit 22 compares the device authentication information stored in the memory 15 with the device authentication information acquired from the reception unit 21, thereby performing the authentication process. In addition, the authentication processing unit 22 outputs the authentication result to the controller 26. Further, when the authentication is successful, the authentication processing unit 22 outputs device user identification information of the authenticated user to the file name setting unit 25.

For example, the user authentication process is performed in order to restrict use of the functions of the image forming device 1 for each user. As an example, a user who is not authenticated by the authentication processing unit 22 may be allowed to use the predefined minimum functions, and a user who is authenticated by the authentication processing unit 22 may be allowed to use all the functions of the image forming device 1. For example, a non-authenticated user may be allowed to perform only monochrome printing and monochrome copying, and an authenticated user may be allowed to perform color printing and color copying. In addition, a non-authenticated user may be restricted in relation to the number of sets. In addition, functions which are allowed to be used may be registered in the image forming device 1 in advance for each user, and the functions allowed to be used may be restricted depending on authentication levels even if a user is authenticated by the authentication processing unit 22.

File Name Generation Unit 23

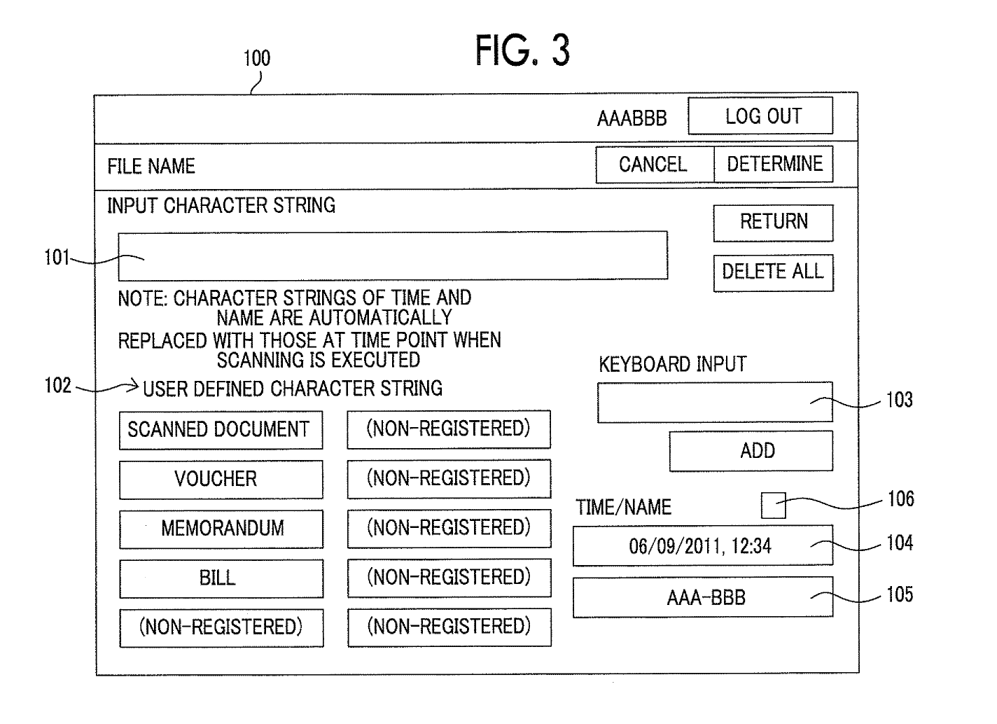

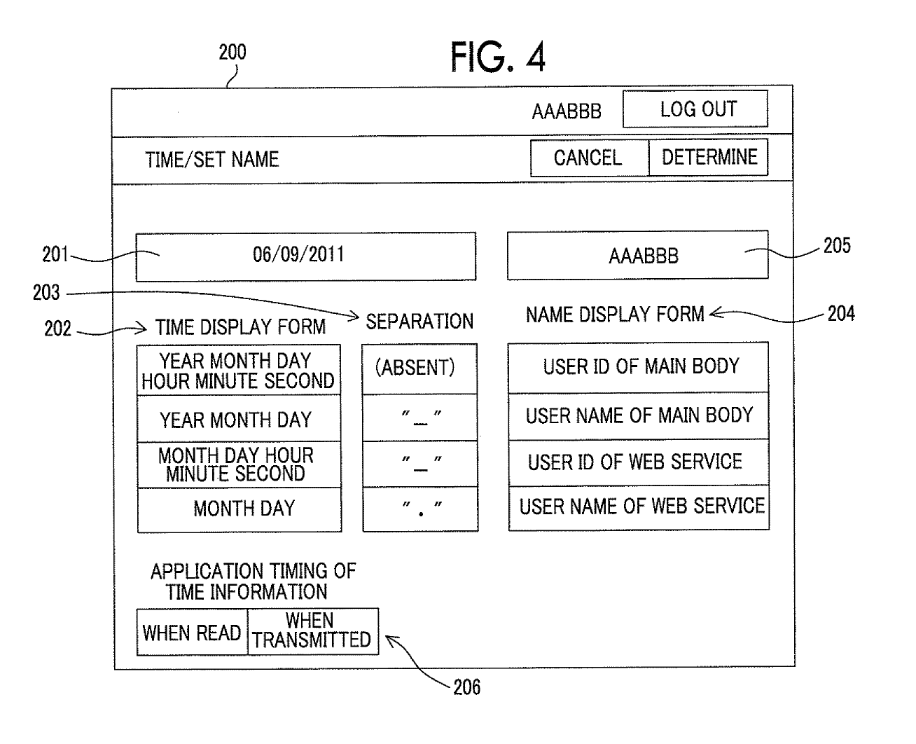

The file name generation unit 23 generates a form of a file name given to image data which is generated and acquired by the image reading unit 12. Specifically, the file name generation unit 23 generates a form of a default file name indicated by a form including time information formed by a character string designated by a user and the date or a time point and user identification information for identifying the user. With reference to FIGS. 3 and 4, procedures of generating a form of a default file name will be described. For example, when a user, an administrator, or the like instructs generation of a form of a default file name by the use of the UI unit 17, the controller 26 displays a setting screen for generation of a form of a default file name on the display 27. FIG. 3 shows an example of the setting screen for generation of a form of a default file name. For example, the setting screen 100 includes a display column 101 of a set and input character string, a user defined character string 102 which is registered in advance, a keyboard input column 103 for inputting an arbitrary character string with a keyboard, a time column 104 for selecting a display form of time information, a name column 105 for selecting a display form of a user name, and a setting button 106.

The user defined character string 102 is candidates of character strings included in a default file name, and is a character string which is registered in the image forming device 1 in advance. For example, when the user, the administrator, or the like inputs a character string (the user defined character string 102) by the use of the UI unit 17, the input character string (the user defined character string 102) is stored in the memory 15. As an example, the character string “scanned document”, the character string “voucher”, the character string “memorandum”, and the character string “bill” are registered as the user defined character string 102, and are displayed on the setting screen 100 so as to be selected by the user. If the character string “scanned document” is selected by the user, the character string “scanned document” is included in a form of the default file name. In addition, if the character string “voucher” is selected by the user, the character string “voucher” is included in a form of the default file name. Further, if the character string “memorandum” is selected by the user, the character string “memorandum” is included in a form of the default file name. In addition, if the character string “bill” is selected by the user, the character string “bill” is included in a form of the default file name.

In addition, character strings other than the user defined character string 102 shown in FIG. 3 may be registered in the image forming device 1 in advance. The keyboard input column 103 is a column for the user inputting a character string by the use of the UI unit 17, for example, in a case where the character string other than the user defined character string 102 is included in a form of the default file name.

The time column 104 is a column for selecting a display form of time information included in a form of the default file name. The name column 105 is a column for selecting a display form of user identification information included in a form of the default file name. The setting button 106 is a button for displaying a setting screen for the user selecting a display form of time information and a display form of user identification information on the display 27.

The display form of time information and the display form of user identification information are selected from a setting screen different from, for example, the setting screen 100. FIG. 4 shows an example of the setting screen for selecting the display form of time information and the display form of user identification information. The setting screen 200 includes display columns 201 and 205, a list 202 of time information display forms, a list 203 of separations, a list 204 of name display forms, and a selection 206 of a timing for application of time information. For example, when the user, the administrator, or the like designates the setting button 106 displayed on the setting screen 100 by the use of the UI unit 17, the controller 26 displays the setting screen 200 on the display 27. The list 202 of time information display forms is a list of candidates of time information display forms included in a form of the default file name. In the exemplary embodiment, the time information may include the month, the day, the year, and the time point. In addition, the time point may include information up to any unit of an hour, a minute and a second. As an example, the time information display form “year month day hour minute second”, the time information display form “year month day”, the time information display form “month day hour minute second”, and the time information display form “month day” are displayed on the setting screen 200 so as to be selected by the user. If the time information display form “year month day hour minute second” is selected by the user, time information is included in a form of the default file name as a form of “year month day hour minute second”. In addition, if the time information display form “year month day” is selected by the user, time information is included in a form of the default file name as a form of “year month day”. Further, if the time information display form “month day hour minute second” is selected by the user, time information is included in a form of the default file name as a form of “month day hour minute second”. In addition, if the time information display form “month day” is selected by the user, time information is included in a form of the default file name as a form of “month day”. The candidates of the time information display forms shown in FIG. 4 are an example, and other display forms may be displayed so as to be selected by the user. In addition, the selection 206 of a timing for application of time information is a display for setting a file name practically and instructing and selecting the kind of process applied to image data on the basis of the form of the default file name. If the user selects “when read”, a file name where a time when an original is scanned and image data is acquired is set as time information is generated and is given to the image data. In addition, if the user selects “when transmitted”, a file name where a time when a process of transmitting the image data to the web service or the information processing device is completed is set as time information is generated and is given to the image data.

The list 203 of separations is a list of separation candidates shown between year, month, day, and the like included in the time information. As an example, the separation “absent”, the separation “_ (under bar)”, the separation “- (hyphen)”, and the separation “. (period)” are displayed on the setting screen 200 so as to be selected by the user. If the separation “absent” is selected by the user, the separation is absent between year, month, day, and the like, and time information is included in the form of the default file name. In addition, the separation “_ (under bar)” is selected by the user, time information is included in the form of the default file name in a state where “_ (under bar)” is provided between year, month, day, and the like. Further, the separation “- (hyphen)” is selected by the user, time information is included in the form of the default file name in a state where “- (hyphen)” is provided between year, month, day, and the like. In addition, the separation “. (period)” is selected by the user, time information is included in the form of the default file name in a state where “. (period)” is provided between year, month, day, and the like. The separation candidates shown in FIG. 4 are an example, and other separations may be displayed so as to be selected by the user.

The list 204 of name display forms is a list of display form candidates of user identification information included in a form of the default file name. As an example, the name display form “user ID of main body”, the name display form “user name of main body”, the name display form “user ID of a web service”, and the name display form “user name of a web service” are displayed on the setting screen 200 so as to be selected by the user as user identification information. The “user ID of main body” is a device user ID of the user for the image forming device 1. The “user name of main body” is the name of the user for the image forming device 1. The “user ID of a web service” is a service user ID of the user for a web service provided by the web server 3. The “user name of a web service” is a user name for a web service provided by the web server 3. If the name display form “user ID of main body” is selected by the user, a device user ID is included in a form of the default file name. In addition, if the name display form “user name of main body” is selected by the user, the name of the user using the image forming device 1 is included in a form of the default file name. Further, if the name display form “user ID of a web service” is selected by the user, a service user ID is included in a form of the default file name. In addition, if the name display form “user name of a web server” is selected by the user, the name of the user using a web service is included in a form of the default file name. As the “user ID of main body”, instead of the device user ID of the user for the image forming device 1, employee numbers may be displayed on the setting screen 200 so as to be selected by the user.

The user, the administrator, or the like selects a time information display form from the list 202 of the time information display forms, selects a separation from the list 203 of the separations, and selects a display form of user identification information from the list 204 of the name display forms by the use of the UI unit 17. The controller 26 displays an example of the time information indicated by the time information display form and the separation selected by the user, the administrator, or the like in the display column 201. In addition, the controller 26 displays an example of the user identification information indicated by the display form of user identification information selected by the user in the display column 205. For example, by the use of the UI unit 17, the user, the administrator, or the like selects the time information display form “year month day” from the list 202 of the time information display forms, selects the separation “_ (under bar)” from the list 203 of the separations, and selects the name display form “user name of main body” from the list 204 of the name display forms. In this case, the controller 26 displays an example of the time information (2011_{—}09_{—}06) indicated by the time information display form “year month day” and the separation “_ (under bar)” selected by the user in the display column 201. In addition, the controller 26 displays an example of the name (AAABBB) indicated in the name display form “user name of main body” selected by the user in the display column 205. As such, the time information display form and the display form of user identification information are selected by the user on the setting screen 200 as an example.

In addition, in a case of generating a form of the default file name, the user, the administrator, or the like selects the user defined character string 102, the time column 104, and the name column 105 on the setting screen 100 shown in FIG. 3, by the use of the UI unit 17. The file name generation unit 23 receives the selections via the reception unit 21, and generates a form of the default file name by combining the user defined character string 102, the time information, and the user identification information in the order selected by the user. Thereby, there is a generation of the form of the default file name in which the user defined character string 102, the time information, and the user identification information are shown in the order selected by the user. The form of the default file name is displayed in the display column 101 of the setting screen 100.

For example, the file name generation unit 23 may set the time information in the form of the default file name to time information at a time point when the user logs in to the image forming device 1, and may set the user identification information in the form of the default file name to user identification information of a user who logs in to the image forming device 1. Alternatively, the file name generation unit 23 may set the time information in the form of the default file name to dummy time information, and may set the user identification information in the form of the default file name to dummy user identification information.

For example, in a case where the user, the administrator, or the like selects the time column 104, the character string “voucher” in the user defined character string 102, and the name column 105 in this order by the use of the UI unit 17, the file name generation unit 23 generates a form of the default file name (time information_voucher_user identification information) including the time information, the character string “voucher”, and the user identification information in the order selected by the user. The time information included in the form of the default file name is indicated in the display form selected from the list 202 of the time information display form. In addition, the user identification information included in the form of the default file name is indicated in the display form selected from the list 204 of the name display forms. As another example, in a case where the user selects the character string “voucher” in the user defined character string 102, the time column 104, and the name column 105 in this order by the use of the UI unit 17, the file name generation unit 23 generates a form of the default file name (voucher_time information_user identification information) including the character string “voucher”, the time information, and the user identification information in the order selected by the user. In this case as well, the time information is indicated in a display form selected from the list 202 of the time information display forms, and the user identification information is indicated in a display form selected from the list 204 of the name display forms. In a case where the character string “scanned document”, the character string “memorandum”, or the character string “bill” is selected by the user instead of the character string “voucher” as well, the file name generation unit 23 generates a form of the default file name including the character string, the time information, and the user identification information in the order selected by the user.

In addition, the user, the administrator, or the like may select plural character strings from the user defined character string 102. In this case as well, the file name generation unit 23 generates a default filename including time information, character strings, and user identification information in the order selected by the user.

The file name generation unit 23 outputs data indicating the form of the default file name to the file name memory 24, and stores the data indicating the form of the default file name in the file name memory 24. For example, when the user designates a “determine” button on the setting screen 100 by the use of the UI unit 17, the file name generation unit 23 outputs data indicating the default file name to the file name memory 24 and stores the data in the file name memory 24.

In addition, the file name generation unit 23 may generate a form of the default file name for each kind of original (document) read by the image reading unit 12. For example, in a case where the user designates the kind of original and selects time information, a character string, and user identification information by the use of the UI unit 17, the file name generation unit 23 generates a form of the default file name including the time information, the character string, and the user identification information in the order selected by the user. In addition, the file name generation unit 23 correlates data indicating the form of the default file name with original identification information for identifying the kind of original designated by the user so as to be stored in the file name memory 24.

For example, in a case of generating a file name form for a voucher, when the user, the administrator, or the like selects the character string “voucher” from the user defined character string 102 by the use of the UI unit 17, the file name generation unit 23 generates a file name including the character string “voucher” as a file name for a voucher. The file name generation unit 23 stores data indicating a form of the file name including the character string “voucher” in the file name memory 24 as data indicating the file name form for a voucher. For example, the file name generation unit 23 correlates the data indicating the file name form for a voucher with original identification information for identifying the voucher so as to be stored in the file name memory 24. The user, the administrator, or the like may input original identification information for identifying a voucher by the use of the UI unit 17, and the file name generation unit 23 may correlate data indicating a file name form for the voucher with the original identification information input by the user so as to be stored in the file name memory 24.

Further, as another example, in a case of generating a file name form for a bill, when the user, the administrator, or the like selects the character string “bill” from the user defined character string 102 by the use of the UI unit 17, the file name generation unit 23 generates a form of a file name including the character string “bill” as a form of a file name for a bill. The file name generation unit 23 stores data indicating a form of the file name including the character string “bill” in the file name memory 24 as data indicating the file name form for a bill. Also for a file name form for a scanned document and a file name form for a memorandum, when the user selects the character string “scanned document” and the character string “memorandum”, respectively, the file name including the character string “scanned document” is generated as the file name form for a scanned document, and a form of the file name including the character string “memorandum” is generated as the file name form for a memorandum.

In addition, the file name generation unit 23 may generate a form of the default file name for each user. In this case, the file name generation unit 23 receives device user identification information for identifying a user and correlates the device user identification information with data indicating the form of the default file name so as to be stored in the file name memory 24.

In addition, device identification information for identifying the image forming device 1 may be included in a form of the default file name. The device identification information corresponds to, for example, a device ID or a device name for identifying the image forming device 1. For example, a button for including device identification information in a form of the default file name is provided in the setting screen 100. When the user, the administrator, or the like designates the button by the use of the UI unit 17, the file name generation unit 23 generates a form of the default file name including device identification information. In this case as well, the file name generation unit 23 generates the form of the default file name including the user defined character string 102, the time information, the user identification information, and the device identification information in the order designated by the user. In addition, the file name generation unit 23 may generate the form of the default file name including the user defined character string 102, the time information, and the device identification information in the order designated by the user.

File Name Memory 24

The file name memory 24 stores the data indicating the form of the default file name generated by the file name generation unit 23. For example, the file name memory 24 stores the data indicating the form of the default file name and an identifier for identifying the form of the default file name in correlation with each other.

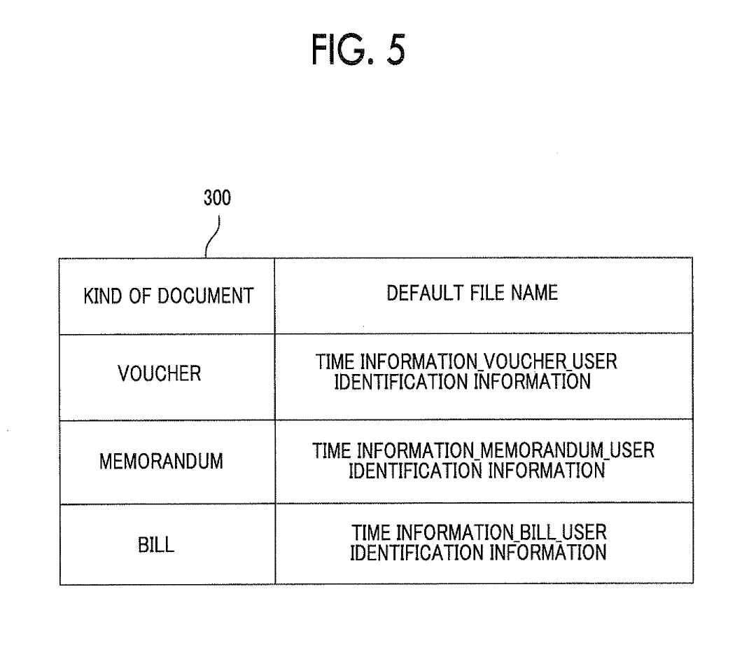

In a case where a form of the default file name for each kind of original (document) is generated by the file name generation unit 23, the file name memory 24 stores data indicating the form of the default file name for each kind of original. In this case, the file name memory 24 stores data indicating the form of the default file name and original identification information for identifying the kind of original in correlation with each other. FIG. 5 shows an example of the form of the default file name for each kind of original. The file name memory 24 stores, for example, management information 300 shown in FIG. 5. The management information 300 is data indicating a form of the default file name correlated with the kind of original. For example, the original “voucher” is correlated with “time information_voucher_user identification information” as a form of the default file name. In addition, the original “memorandum” is correlated with “time information_memorandum_user identification information” as a form of the default file name. Further, the original “bill” is correlated with “time information_bill_user identification information” as a form of the default file name. The management information 300 shown in FIG. 5 is an example, and the management information 300 may include other forms of the default file names.

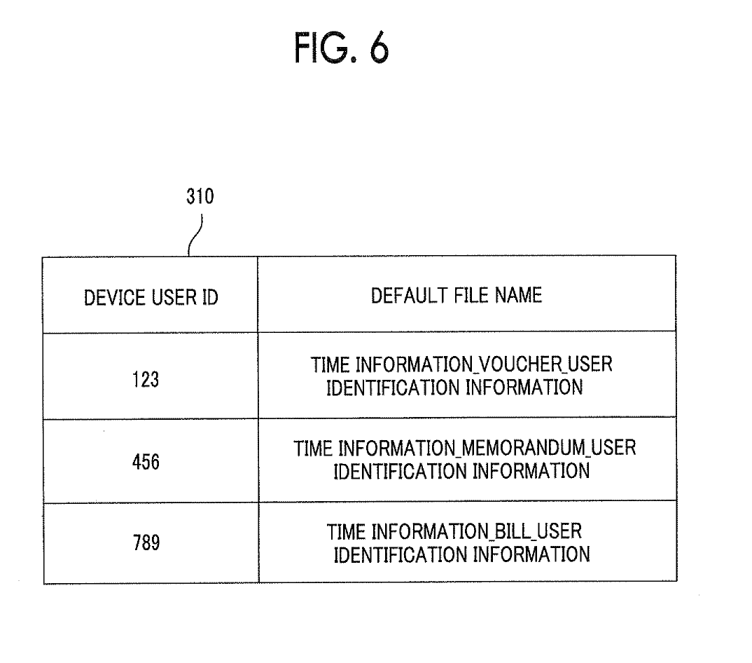

In addition, in a case where a form of the default file name for each user is generated by the file name generation unit 23, the file name memory 24 stores data indicating a form of the default file name for each user. In this case, the file name memory 24 stores data indicating the form of the default file name and user identification information in correlation with each other. FIG. 6 shows an example of the form of the default filename for each user. The file name memory 24 stores, for example, management information 310 shown in FIG. 6. The management information 310 is data indicating a form of the default file name correlated with user identification information. In the example shown in FIG. 6, a device user ID is correlated with a form of the default file name. For example, the device user ID “123” is correlated with “time information_voucher_user identification information” as a form of the default file name. In addition, the device user ID “456” is correlated with “time information_memorandum_user identification information” as a form of the default file name. Further, the device user ID “789” is correlated with “time information_bill_user identification information” as a form of the default file name. The management information 310 shown in FIG. 6 is an example, and the management information 310 may include other forms of the default file names.

File Name Setting Unit 25

The file name setting unit 25 reads the data indicating the form of the default file name designated by the user from the file name memory 24, and sets the time information and the user identification information of the form of the default file name to time information when an image is read by the image reading unit 12 and user identification information of the user which instructs reading of the image, thereby generating a file name. For example, when the user designates an identifier by the use of the UI unit 17, the file name setting unit 25 reads data indicating a form of the default file name correlated with the identifier designated by the user from the file name memory 24. The file name setting unit 25 receives time information indicating time when an original is read by the image reading unit 12 and image data is acquired from the controller 26, and sets time information of the form of the default file name to time indicated by the time information. In addition, in a case where the user is authenticated by the authentication processing unit 22, the file name setting unit 25 receives device user identification information of the user authenticated by the authentication processing unit 22 from the authentication processing unit 22, and sets user identification information of the form of the default file name to device user identification information of the authenticated user. Further, the file name setting unit 25 may receive service user identification information from the reception unit 21, and set user identification information of the form of the default file name to the service user identification information. The file name setting unit 25 gives the file name in which the time information and the user identification information are set to image data which is read and acquired by the image reading unit 12, and outputs the image data given the file name to the access unit 28. In addition, time set as the time information by the file name setting unit 25 is not only the time when image data read and acquired by the image reading unit 12 is acquired, but may also be the time when the facsimile unit 14 receives a facsimile document and performs an acquisition process of image data, the time when a transmission process of the acquired image data is performed, or the time when the transmission process of the image data is completed. Further, in a case where a form of the default file name is set, as time which is set as the time information, the above-described process timing may be selected and set. This timing may be determined on the basis of designation of the selection 206 of a timing of application of time information shown in FIG. 4.

Controller 26

The controller 26 controls the respective units of the image forming device 1. For example, the controller 26 outputs time information indicating time when the image reading unit 12 reads an image to the file name setting unit 25. The time when the image is read includes, for example, year, month, day, hour, minute, and second. The controller 26 displays a variety of information on the display 27.

Display 27

The display 27 is, for example, a display section of the UI unit 17, and displays a variety of screens under the control of the controller 26. For example, the display 27 displays an initial menu screen of the image forming device 1, a login screen to the image forming device 1, a menu screen for a user authenticated by the image forming device 1, a screen for generating a form of the default file name, a screen for causing a user to select the kind of original (document) which is a scanning target, and the like. Data of the screens displayed on the display 27 is stored in, for example, the memory 15 in advance, and the controller 26 displays a screen based on the data stored in the memory 15 on the display 27.

Access Unit 28

The access unit 28 accesses the web server 3 or the information processing device 4 via the communication path 2 by the communication unit 16 under the control of the controller 26 so as to transmit data to the web server 3 or the information processing device 4 or receive data from the web server 3 or the information processing device 4. For example, the access unit 28 transmits image data generated by the image reading unit 12 to the web server 3 or the information processing device 4 designated by the user.

In addition, the respective functions shown in FIG. 3 are realized by the CPU 11 executing the programs stored in the memory 15; however, a part thereof may be constituted by hardware. For example, the CPU 11 executes the programs stored in the memory 15, and thereby the respective functions of the reception unit 21, the authentication processing unit 22, the file name generation unit 23, the file name setting unit 25, the controller 26, and the access unit 28 are realized. The programs are stored in the memory 15 via a recording medium such as a CD or a DVD, or via a communication path such as a network. In addition, the programs may be stored in the memory 15 in advance. The programs stored in the memory 15 are read to another memory and are executed by the CPU 11, thereby realizing the above-described functions of the respective units. In addition, the file name memory 24 may be constituted by the memory 15.

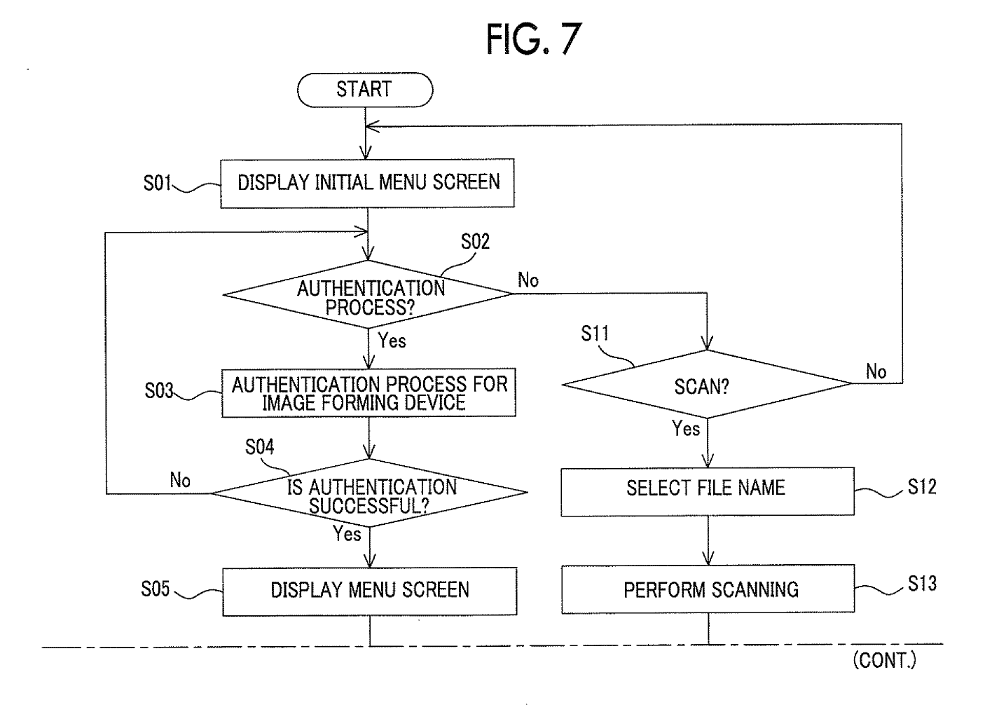

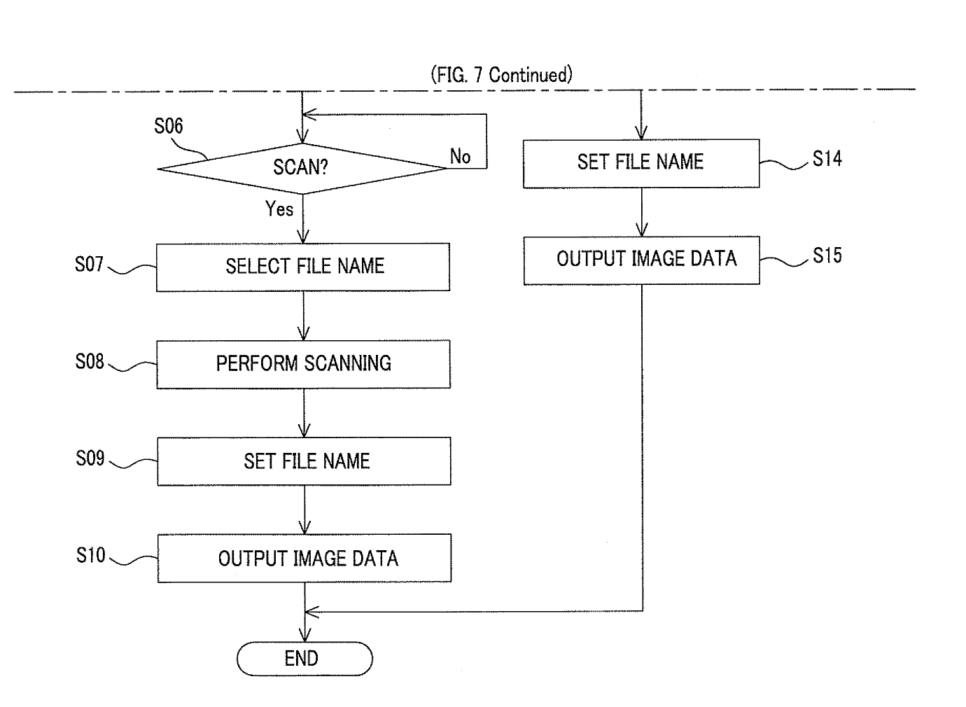

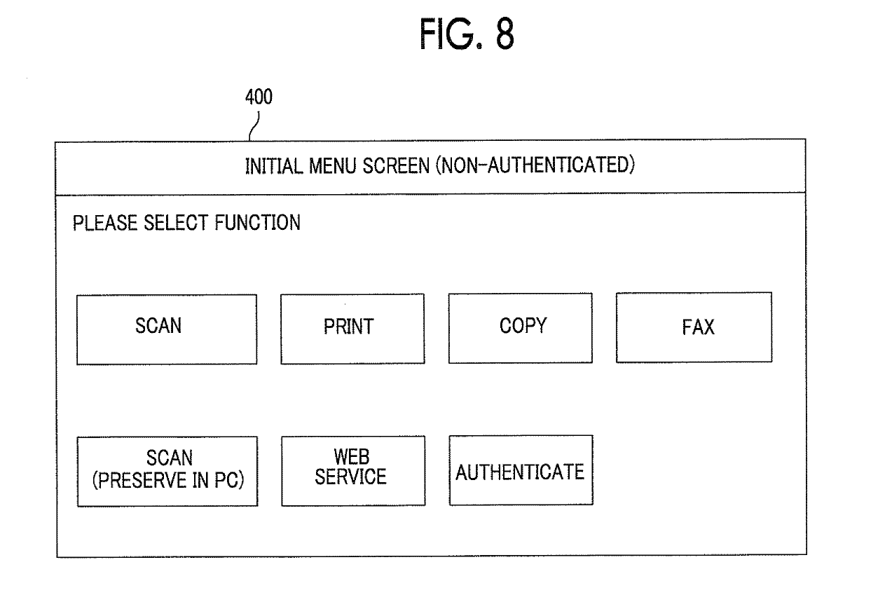

Next, an example of the process performed by the image forming device 1 will be described with reference to a flowchart shown in FIG. 7. First, the controller 26 displays an initial menu screen on the display 27 (S01). FIG. 8 shows an example of the initial menu screen. For example, on the initial menu screen 400, functions of the image forming device 1 (a scan function, a print function, a copy function, and a facsimile function), a function (scan (preserve in PC)) where an image is read (scanned), image data is transmitted to the information processing device 4, and the information processing device 4 preserves the image data, and a web service function are displayed in a state selected by a user. In the exemplary embodiment, the web service function is a function where an image is scanned, image data is transmitted to the web server 3, and the web server 3 preserves the image data. In addition, a process where an image is scanned, and image data is transmitted to the web server 3 or the information processing device 4 so as to be preserved is referred to as “scan upload” in some cases in the following description. In this step, an authentication process of the user for the image forming device 1 is not performed. The user may designate any one item of “scan (image reading)”, “print”, “copy”, “FAX (facsimile)”, “scan (preserve in PC)”, “web service”, and “authenticate” on the initial menu screen 400 by the use of the UI unit 17. The “authenticate” item is an item for instructing an authentication process of the user for the image forming device 1.

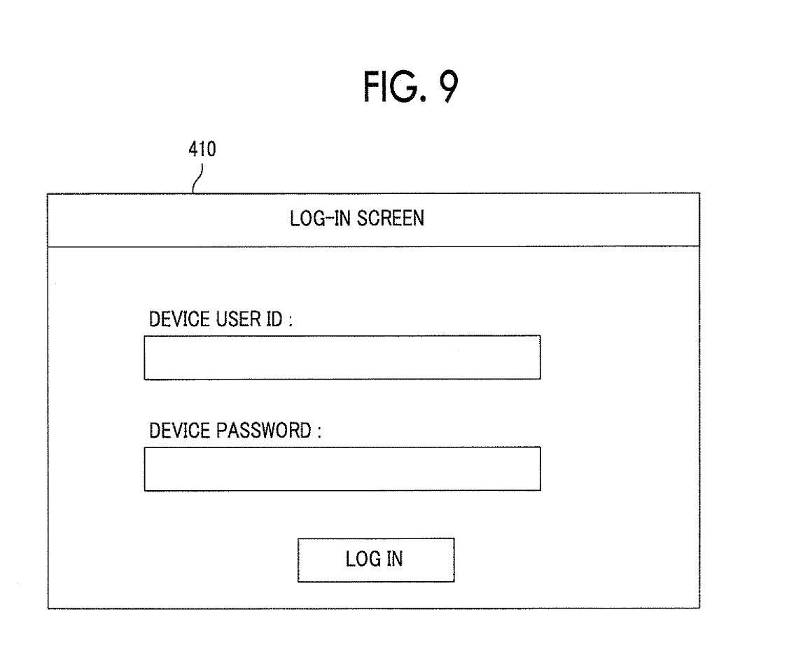

In addition, when the user selects the “authenticate” item on the initial menu screen 400 by the use of the UI unit 17 in order to be authenticated by the image forming device 1 and log in to the image forming device 1 (S02, Yes), an authentication process is performed by the authentication processing unit 22 (S03). For example, an IC card in which device identification information is stored is touched on the card reader provided in the image forming device 1, and thereby the device identification information is input to the image forming device 1. The reception unit 21 receives device authentication information including device user identification information and a device password and outputs the device authentication information to the authentication processing unit 22. In addition, for example, as shown in FIG. 9, the controller 26 may display a login screen 410 for authentication on the display 27, and the user may input a device user ID and a device password on the login screen 410. The authentication processing unit 22 receives the device authentication information from the reception unit 21, performs an authentication process of the user for the image forming device 1 on the basis of the device authentication information, and outputs the authentication result to the controller 26. In addition, if the authentication is successful, the authentication processing unit 22 outputs device user identification information of the user who succeeds an the authentication to the file name setting unit 25.

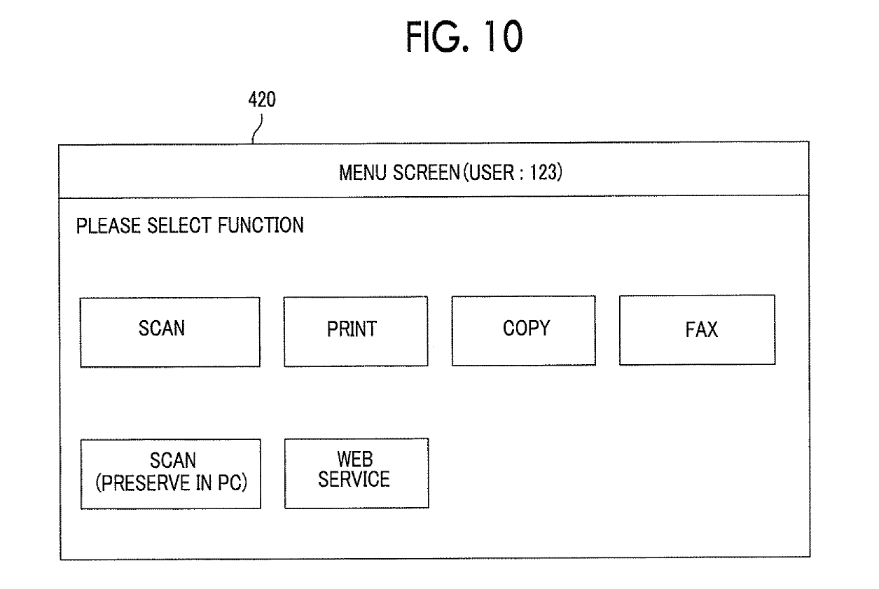

If the authentication is successful by the authentication processing unit 22 (S04, Yes), the controller 26 displays a menu screen for the user authenticated by the image forming device 1 on the display 27 (S05). FIG. 10 shows an example of the menu screen. For example, on the menu screen 420, functions of the image forming device 1 which the authenticated user is allowed to use (a scan function, a print function, a copy function, and a facsimile function), a scan (preserve in PC) function, and a web service function are displayed in a state selected by a user. In addition, the use of the functions of the image forming device 1 and the use of the web service function may be restricted for each user, and the controller 26 displays a menu screen for each user on the display 27.

For example, the menu screen 420 shown in FIG. 10 is a menu screen for the user whose device user ID is “123”. The user whose device user ID is “123” is allowed to use the scan function, the print function, the copy function, and the facsimile function, the scan (preserve in PC) function, and the web service function.

On the other hand, if the authentication fails (S04, No), the controller 26 displays information indicating that the authentication fails on the display 27, and the process returns to, for example, step S02.

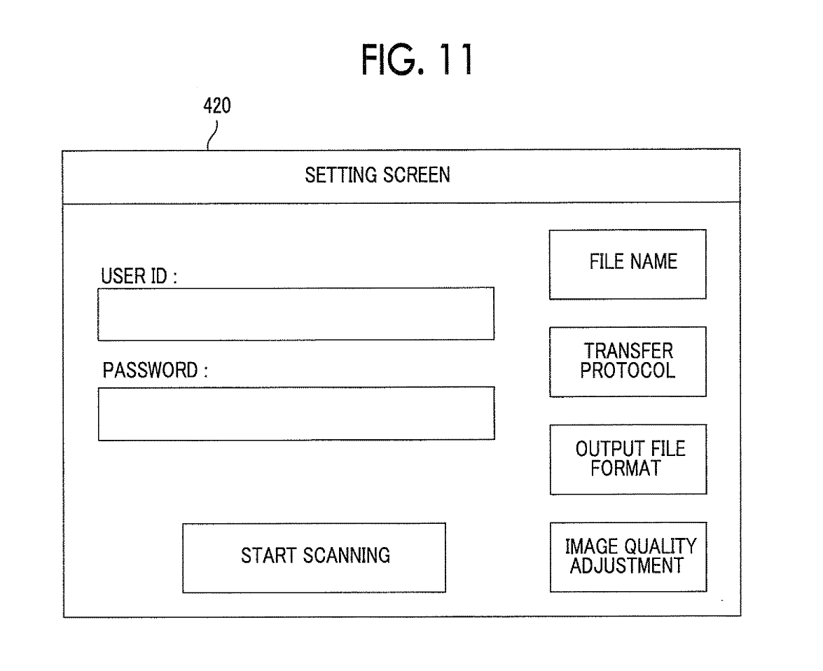

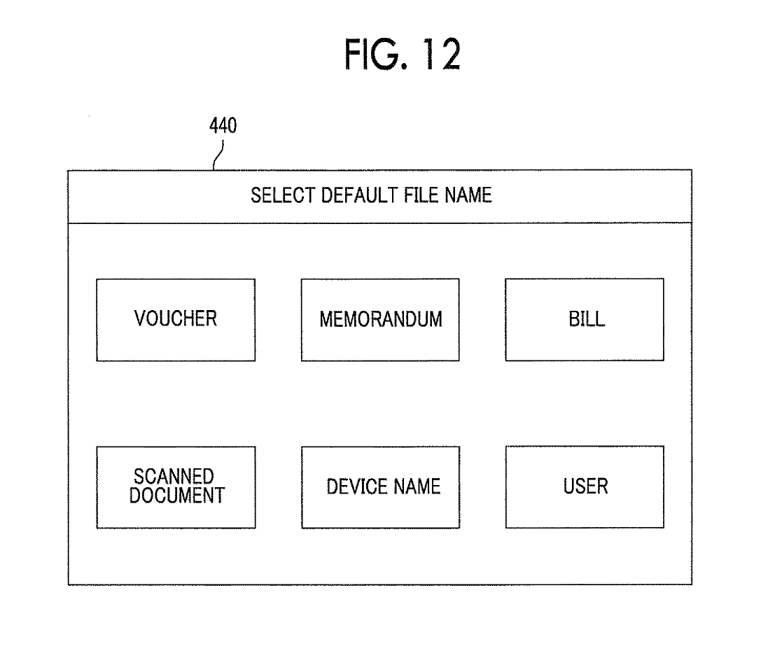

In addition, in a case where the user designates a function regarding the scan upload on the menu screen 420 by the use of the UI unit 17 (S06, Yes), a process for causing the user to select a form of the default file name is performed (S07). For example, when the web service function is designated by the user, the controller 26 displays a setting screen for using a web service on the display 27. FIG. 11 shows an example of the setting screen. The setting screen 430 includes, for example, a column for inputting service authentication information (a service user ID and a service password) for using a web service, an item for selecting a form of the default file name, an item for setting a protocol for transferring image data, an item for selecting a file format of image data, an item for adjusting image quality of image data, and the like. For example, the user, the administrator, or the like inputs a service user ID or a service password by the use of the UI unit 17. In addition, if the user, the administrator, or the like designates the item for selecting a form of the default file name by the use of the UI unit 17, the controller 26 displays a setting screen for causing the user to select a form of the default file name on the display 27. FIG. 12 shows an example of the setting screen for causing the user to select a form of the default file name. On the setting screen 440, the items “voucher”, “memorandum”, “bill”, “scanned document”, “device name” and “user” are displayed in a state selected by the user. For example, when the user designates the item “voucher” by the use of the UI unit 17, the file name setting unit 25 receives the designation via the reception unit 21, and reads data indicating a form of the default file name for a voucher from the file name memory 24. In the management information 300 shown in FIG. 5, the “voucher” is correlated with “time information_voucher_user identification information” as a form of the default file name, and thus the file name setting unit 25 reads data indicating the form of the default file name (“time information_voucher_user identification information”) from the file name memory 24. In addition, when the user designates the item “user” by the use of the UI unit 17, the file name setting unit 25 receives the designation via the reception unit 21, and reads data indicating a form of the default file name correlated with device user identification information of the user who logs in to the image forming device 1, from the file name memory 24. For example, a description will be made of a case where a device user ID of the user who logs in to the image forming device 1 is “123”. In the management information 310 shown in FIG. 6, the device user ID “123” is correlated with “time information_voucher_user identification information” as a form of the default file name, and thus the file name setting unit 25 reads data indicating the form of the default file name (“time information_voucher_user identification information”) from the file name memory 24. In addition, when the user designates the item “device name” by the use of the UI unit 17, the file name setting unit 25 receives the designation via the reception unit 21, and reads data indicating a form of the default file name including device identification information of the image forming device 1 from the file name memory 24.

Further, in a case where the scan (preserve in PC) function is designated on the menu screen 420 as well, the controller 26 displays a setting screen for connection to the information processing device 4 or a setting screen for causing the user to select a form of the default file name on the display 27.

In addition, the selection of a form of the default file name, the setting for using a web service, and the setting for connection to the information processing device 4 are not performed in step S07 but may be performed in advance. In addition, in step S07, a form of the default file name may be generated by the file name generation unit 23. In this case, in step S07, the controller 26 may display the setting screen 100 shown in FIG. 3 and the setting screen 200 shown in FIG. 4 on the display 27, and the user may select the user defined character string 102, a display form of time information, and a display form of user identification information, on the setting screens 100 and 200.

When the user instructs starting of scanning by the use of the UI unit 17, the image reading unit 12 reads an image of an original under the control of the controller 26 so as to generate image data (S08). The image data generated by the image reading unit 12 is stored in the memory 15.

The file name setting unit 25 sets the time information and the user identification information of the form of the default file name to time when the image is read by the image reading unit 12 and user identification information of the user instructing reading of the image (S09).

For example, when “time information_voucher_user identification information” is selected as a form of the default file name, “scanning time_voucher_user identification information of the user instructing scanning” is set as a file name. The scanning time is indicated by a display form of the time information included in the form of the default file name. In other words, the scanning time is indicated by a display form selected from the list 202 of the time information display forms shown in FIG. 4. Similarly, the user identification information of the user instructing scanning is indicated by a display form of the user identification information included in the form of the default file name. In other words, the user identification information of the user instructing scanning is indicated by a display form selected from the list 204 of the name display forms shown in FIG. 4.

For example, the file name setting unit 25 receives time information indicating time when an image is read by the image reading unit 12 from the controller 26 and sets the time information of the form of the default file name to the time indicated by the time information. In a case where a display form of the time information of the form of the default file name is “year month day hour minute second”, the file name setting unit 25 sets the time information (year, month, day, hour, minute, second) of the form of the default file name to the time (year, month, day, hour, minute, second) when the image is read. Another example, in a case where a display form of the time information of the form of the default file name is “year month day”, the file name setting unit 25 sets the time information (year, month, day) of the form of the default file name to the time (year, month, day) when the image is read.

In addition, in a case where the name display form of the form of the default file name is a “user ID of main body”, for example, the filename setting unit 25 receives device user identification information of a user authenticated by the authentication processing unit 22 from the authentication processing unit 22, and sets the user identification information of the form of the default file name to the device user ID of the user authenticated by the authentication processing unit 22. As another example, in a case where the name display form of the form of the default file name is a “user ID of web service”, the file name setting unit 25 receives service user identification information for a web service from the reception unit 21, and sets the user identification information of the form of the default file name to the service user ID for the web service. In addition, the user, the administrator, or the like may input service user identification information for a web service by the use of the UI unit 17, and the reception unit 21 may receive the service user identification information input by the user so as to be output to the file name setting unit 25.

Also for a form of the default file name including the character string “memorandum”, a file name is set to “scanning time_memorandum_user identification information of the user instructing scanning”. In addition, also for a form of the default file name including the character string “bill”, a file name is set to “scanning time_bill_user identification information of the user instructing scanning”.

In addition, in a case where a form of the default file name including a character string, time information, user identification information, and device identification information is selected, the file name setting unit 25 sets the time information, the user identification information and the device identification information of the form of the default file name to scanning time, user identification information of a user instructing scanning, and device identification information of the image forming device 1 performing the scanning.

In addition, the file name setting unit 25 gives the set file name to the image data generated by the image reading unit 12, and outputs the image data given the file name to the access unit 28.

In a case where the web service function is designated by the user on the menu screen 420 shown in FIG. 10, the access unit 28 accesses the web server 3 via the communication path 2 by the communication unit 16 and transmits the image data given the file name to the web server 3 (S10). The web server 3 receives the image data given the file name from the image forming device 1 via the communication path 2 and stores the image data. In addition, in a case where the scan (preserve in PC) function is designated by the user on the menu screen 420, the access unit 28 accesses the information processing device 4 via the communication path 2 by the communication unit 16 and transmits the image data given the file name to the information processing device 4 (S10). The information processing device 4 receives the image data given the file name from the image forming device 1 via the communication path 2 and stores the image data.

In addition, the web server 3 may check whether or not the file name of the image data transmitted from the image forming device 1 is a file name whose use is allowed in the web server 3. In a case where the use of the file name of the image data is not allowed in the web server 3, the web server 3 may transmit error information indicating that the use of the file name of the image data is not allowed to the image forming device 1 via the communication path 2. In addition, in a case where the file name of the image data transmitted from the image forming device 1 overlaps a file name of image data which is preserved in the web server 3 in advance, the web server 3 may transmits error information indicating that the file names overlap each other to the image forming device 1 via the communication path 2. The controller 26 may receive the error information via the communication path 2 by the communication unit 16 and display the error information on the display 27. The user of the image forming device 1 may refer to the error information, change the file name of the image data, and transmit the image data whose file name is changed to the web server 3.

In the same manner as the web server 3, the information processing device 4 may also check whether or not the file name of the image data transmitted from the image forming device 1 is a file name which is allowed to be used in the information processing device 4, and if not allowed to be used, error information may be transmitted to the image forming device 1. In addition, in a case where the file name of the image data transmitted from the image forming device 1 overlaps a file name of image data which is preserved in the information processing device 4 in advance, the information processing device 4 may transmits error information to the image forming device 1.

On the other hand, in a case where the user uses a function regarding the scan upload in a non-authentication state of not logging in to the image forming device 1 (S02, No), the user selects the scan (preserve in PC) function or the web service function by the use of the UI unit 17 (S11). For example, when the user designates the web service function on the initial menu screen 400 shown in FIG. 8 (S11, Yes), a process for causing the user to select a form of the default file name is performed (S12). In the same manner as the process in step S07, the controller 26 displays, for example, the setting screen 430 shown in FIG. 11 and the setting screen 440 shown in FIG. 12 on the display 27. When the user designates a form of the default file name by the use of the UI unit 17, the file name setting unit 25 reads data indicating the form of the default file name designated by the user from the file name memory 24. In addition, in a case as well where the scan (preserve in PC) function is designated on the initial menu screen 400, the controller 26 displays a setting screen for connection to the information processing device 4 or a setting screen for causing the user to select a form of the default file name on the display 27. In addition, the selection of a form of the default file name, the setting for using a web service, and the setting for connection to the information processing device 4 are not performed in step S12 but may be performed in advance. Further, in step S12, a form of the default file name may be generated by the file name generation unit 23.

In addition, when the user instructs starting of scanning by the use of the UI unit 17, the image reading unit 12 reads an image of an original and generates image data under the control of the controller 26 (S13). The image data generated by the image reading unit 12 is stored in the memory 15.

The file name setting unit 25 sets the time information of the form of the default file name to time when the image is read by the image reading unit 12 (S14). In addition, since the user does not log in to the image forming device 1, user identification information is not acquired. In other words, since an authentication process is not performed by the authentication processing unit 22, the file name setting unit 25 does not acquire user identification information of the user instructing the reading of the image. In this case, the file name setting unit 25 may omit the user identification information of the form of the default file name and generate a file name which does not include the user identification information. In addition, the controller 26 may display error information indicating that the user identification information is not acquired on the display 27. In addition, the file name setting unit 25 gives the set file name to the image data generated by the image reading unit 12, and outputs the image data given the file name to the access unit 28.

In the same manner as the process in step S10, the access unit 28 accesses the web server 3 or the information processing device 4 via the communication path 2 by the communication unit 16 and transmits the image data given the file name to the web server 3 or the information processing device 4 (S15).

As above, the image forming device 1 according to the exemplary embodiment sets the time information and the user identification information of the form of the default file name to a file name including time when a process for data such as scanning or transmission is performed and user identification information of the user instructing the process for each piece of processed data, and gives the file name to the data. In other words, the file name which is set according to the time when a process such as scanning or transmission is performed and the user instructing the process is given to the data. Thereby, even if a predefined character string is included in a form of the default file name, time when the process is performed and a user instructing the process may be specified based on the file name.

For example, in a case where a document regarding a routine work is read by the image forming device, image data regarding the routine work is generated, and the generated image data is registered in an external device, if a form of the default file name indicating the routine work is selected, a character string indicating the routine work is included in a file name, and time when a scanning process is performed and a user instructing the scanning process are included in the file name. For this reason, what kind of routine work is indicated by the image data may be specified on the basis of the file name, and time when scanning is performed and a user instructing the scanning may be specified on the basis of the file name. Thereby, for example, even in a case where plural users scan documents regarding routine works and perform registration works by the use of the image forming device 1, the kinds of routine works, time when the scanning is performed, and users instructing the scanning may be specified on the basis of the file name. For example, in a case where “time information_voucher_user identification information” is selected as a form of the default file name, and a file name where the time information and the user identification information are set to time when scanning is performed and user identification information of a user instructing the scanning is given to generated image data, it may be specified that the image data is image data regarding “voucher”, and the time when the scanning is performed and the user may be specified on the basis of the given file name.

Therefore, even in a case where image data is transmitted to the web server 3 or the information processing device 4 from the image forming device 1 and is preserved without designating a preservation destination (folder) in the web server 3 or the information processing device 4, image data regarding a specific document, image data generated at specific time, or image data generated by instruction of a specific user may be specified (searched) on the basis of a file name of the image data.

In addition, in a case where a form of the default file name including device identification information is selected, the device identification information is set to device identification information of the image forming device 1 which performs scanning, and thus the image forming device 1 which performs scanning may be specified on the basis of a file name.

In addition, if a form of the default file name is created in advance, the burden of input tasks on the user is reduced as compared with a case where the user inputs a file name to the image forming device 1 each time.

In addition, the management information 300 shown in FIG. 5 or the management information 310 shown in FIG. 6 may not be created in the image forming device 1 but created in other devices. For example, the information processing device 4 may create the management information 300 and 310 and transmit the management information 300 and 310 to the image forming device 1 via the communication path 2. The image forming device 1 may receive the management information 300 and 310 from the information processing device 4 via the communication path 2 and store the management information 300 and 310 in the file name memory 24. In this case, the image forming device 1 may not include the file name generation unit 23.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device comprising:
an image reading unit that reads an image on an original and generates image data; and
a file name setting unit that sets a time and user identification information of a default file name to a time when an image is read by the image reading unit and user identification information of a user instructing the image reading unit to read the image, and gives a set file name to the image data generated by the image reading unit, in a case where the default file name indicated in a form including a character string registered in advance, the time, and the user identification information for identifying a user are received, and the image is read by the image reading unit.

2. The image forming device according to claim 1, wherein the file name setting unit receives the default file name including a character string according to the kind of original read by the image reading unit and sets the time and the user identification information.

3. The image forming device according to claim 1, further comprising:
an authentication processing unit that performs an authentication process of a user for a use authority of image processes including reading of an image by the image reading unit,
wherein, in a case where a user is authenticated by the authentication processing unit, the file name setting unit sets the user identification information of the default file name to user identification information for identifying the user authenticated by the authentication processing unit.

4. The image forming device according to claim 2, further comprising:
an authentication processing unit that performs an authentication process of a user for a use authority of image processes including reading of an image by the image reading unit,
wherein, in a case where a user is authenticated by the authentication processing unit, the filename setting unit sets the user identification information of the default file name to user identification information for identifying the user authenticated by the authentication processing unit.

5. The image forming device according to claim 3, wherein the file name setting unit receives the default file name for each user and sets the time and the user identification information by the use of the default file name corresponding to a user authenticated by the authentication processing unit.

6. The image forming device according to claim 4, wherein the file name setting unit receives the default file name for each user and sets the time and the user identification information by the use of the default file name corresponding to a user authenticated by the authentication processing unit.

7. The image forming device according to claim 1, further comprising:
an authentication processing unit that performs an authentication process of a user for a use authority of image processes including reading of an image by the image reading unit,
wherein, in a case where a user is not authenticated by the authentication processing unit, the file name setting unit sets the time of the default file name to a time when an image is read by the image reading unit, generates a file name which does not include the user identification information, and gives the file name to the image data.

8. The image forming device according to claim 2, further comprising:
an authentication processing unit that performs an authentication process of a user for a use authority of image processes including reading of an image by the image reading unit,
wherein, in a case where a user is not authenticated by the authentication processing unit, the file name setting unit sets the time of the default file name to a time when an image is read by the image reading unit, generates a file name which does not include the user identification information, and gives the file name to the image data.

9. The image forming device according to claim 1, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

10. The image forming device according to claim 2, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

11. The image forming device according to claim 3, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

12. The image forming device according to claim 4, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

13. The image forming device according to claim 5, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

14. The image forming device according to claim 6, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

15. The image forming device according to claim 7, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

16. The image forming device according to claim 8, further comprising:
a file name generation unit that combines a character string selected by a user from a plurality of character strings which are registered in advance, time indicated in a display form selected by the user from a plurality of display forms related to time, and user identification information indicated in a display form selected by the user from a plurality of display forms related to user identification information, in the order selected by the user, and generates the default file name.

17. A non-transitory computer readable medium storing a program causing a computer to execute a process, the process comprising:
setting time and user identification information of a default file name to time when an image is read by an image reading unit and user identification information of a user instructing the image reading unit to read the image, and
giving a set file name to image data generated by the image reading unit,
in a case where the default file name indicated in a form including a character string registered in advance, the time, and the user identification information for identifying a user are received, and the image is read by the image reading unit.

18. An image forming method comprising:
setting time and user identification information of a default file name to time when an image is read and user identification information of a user instructing reading of the image, and
giving a set file name to generated image data,
in a case where the default file name indicated in a form including a character string registered in advance, the time, and the user identification information for identifying a user are received, and the image is read.
